(19) United States
(12) Patent Application Publication
(10) Pub. No.: US 2019/0187469 A1
(43) Pub. Date: Jun. 20, 2019

(54) DISPLAY ADAPTOR DEVICE

(71) Applicant: Edo Segal, New York, NY (US)

(72) Inventor: Edo Segal, New York, NY (US)

(21) Appl. No.: 16/222,503

(22) Filed: Dec. 17, 2018

Related U.S. Application Data
(60) Provisional application No. 62/599,753, filed on Dec. 17, 2017.
(60) Provisional application No. 62/713,816, filed on Aug. 2, 2018.

(51) Int. Cl. G02B 27/01; G02B 27/14; G06K 7/10

(52) U.S. Cl. CPC G02B 27/0149; G02B 27/142; H02J 7/025; G02B 2027/0161; G06K 7/10297

(57) ABSTRACT

A display device adaptor includes a supporting body that defines a first plane and supports a light projection or electronic display device. The display device adaptor includes a beam splitter mirror to transmit a portion of light incident upon a surface and reflect a portion of light incident upon a surface. The beam splitter mirror is oriented such that the light generated by the light projection or electronic display device is reflected. The beam splitter mirror is coupled to the supporting body and pivotable about an axis. The display device adaptor also includes a coupling device that attaches the display device adaptor to a surface.

### CROSS-REFERENCE TO RELATED APPLICATION

This patent application is based on and claims priority to U.S. Provisional Patent Application 62/599,753, filed Dec. 17, 2017, and this patent application is based on and claims priority to U.S. Provisional Patent Application 62/713,816, filed Aug. 2, 2018, the entire contents of both of which are incorporated by reference as if expressly set forth in their respective entireties herein.

### FIELD OF THE INVENTION

The present invention is directed to configurable display adaptor devices having transparent or semi-transparent display surfaces.

### BACKGROUND OF THE INVENTION

There exits in the art teleprompters and heads-up displays. These types of devices project content generated by an electronic display onto a semi-transparent surface. An observer of this semi-transparent surface is able to view the content projected, as well as events transpiring behind the display. As a result, an observer is able to evaluate both an event and contextual information regarding that event simultaneously. However, such devices have drawbacks and limitations.

Teleprompters and the like are commonly used only for displaying text and not for video or mixed media content. Furthermore, teleprompters require custom monitor setups, black traps, and other specialized, expensive equipment. This equipment must be set up with some advanced notice, and is often cumbersome for a single individual to use.

What is needed in the technical field are easy to use, portable, cost effective devices that provide semi-transparent surfaces for use in connection with widely available display device hardware.

### SUMMARY OF THE INVENTION

In one particular implementation of the display device adaptor described herein, a supporting body is provided that defines a first plane and is configured to support a light projection or electronic display device. The display device adaptor also includes a beam splitter mirror configured to transmit a portion of light incident upon a surface and reflect a portion of light incident upon a surface. The beam splitter mirror is oriented such that the light generated by the light projection or electronic display device is reflected by the beam splitter mirror. The beam splitter mirror is coupled to the supporting body and pivotable about an axis. Here, the beam splitter mirror is configured to move from a closed position oriented in parallel with the first plane defined by the supporting body and a viewing position that orients the beam splitter mirror at an angle relative to the first plane. For instance, the beam splitter is inclined at a 45-degree angle relative to the plane defined by the supporting body. The display device adaptor also includes a coupling device that attaches the display device adaptor to a surface.

In a particular further implementation of the display device adaptor, the display device supported by the supporting body is a portable computing device having at least one output display. In a further configuration, the supporting body also includes a securing device that secures the display device (such as a smartphone) to the supporting body to prevent slippage.

In yet a further implementation, the supporting body also includes a power supply and/or a wireless charging interface to charge or power a portable display device.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 illustrates a side isometric view of the display device adaptor with the beam splitter mirror in a closed position.

FIG. 2A illustrates a side isometric view of the display device adaptor with the beam splitter mirror in an open position.

FIG. 2B illustrates a side isometric view of the display device adaptor with the beam splitter mirror in an open position and details light paths incident upon the beam splitter mirror.

FIG. 3 illustrates a bottom isometric view of the display device adaptor with the beam splitter mirror in an open position.

FIG. 4 illustrates a top view of the display device adaptor with the beam splitter mirror in a closed position.

FIG. 5 illustrates a back isometric view of the display device adaptor with the beam splitter mirror in an open position.

FIG. 6 illustrates a side view of the display device adaptor with the beam splitter mirror in an open position.

FIG. 7 illustrates a front isometric view of the display device adaptor with the beam splitter mirror in an open position.

FIG. 8 illustrates a flow chart indicating particular interconnections between elements of the display device adaptor described herein.

FIG. 9 is a diagram illustrating an example hardware arrangement that operates for providing the systems and methods disclosed herein, in accordance with an alternative implementation of the present application;

FIG. 10A is an illustration of a crystalline portion during an etching process for creating the etched mask portion;

FIG. 10B is a diagram illustrating an example crystal component that includes etched mask portion shown therein;

FIG. 10C illustrates example crystal component that includes etched mask portion and an image of a person projected on to etched mask;

FIGS. 11A-11D illustrate example implementations of at least portions of system and an alternative implementation; and

FIG. 12 illustrates an example implementation in which a user is engaged in a videoconference session and using technology shown and described herein.

### DETAILED DESCRIPTION OF CERTAIN EMBODIMENTS OF THE INVENTION

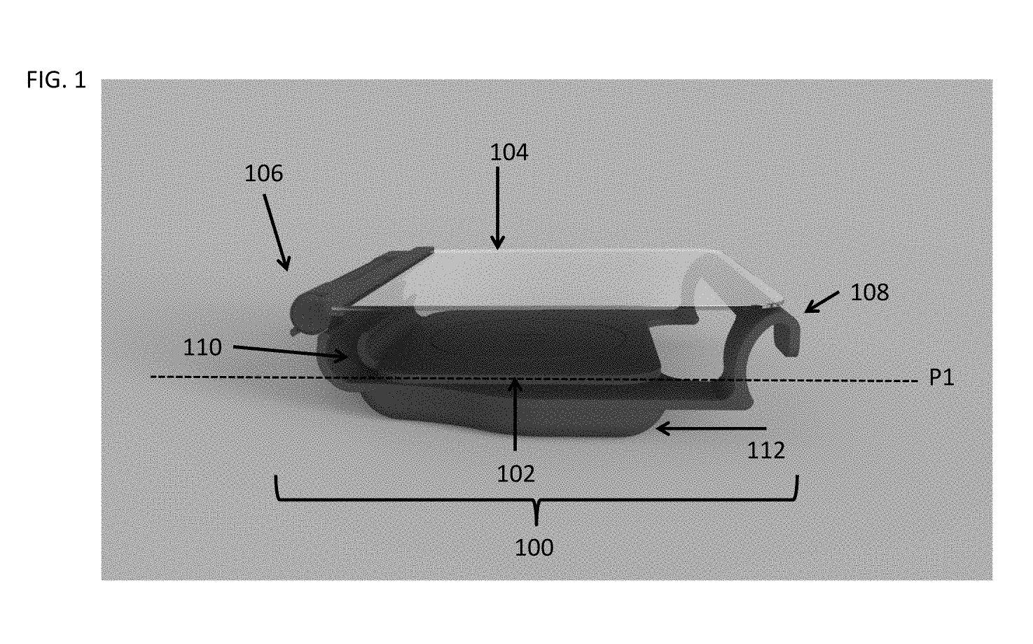

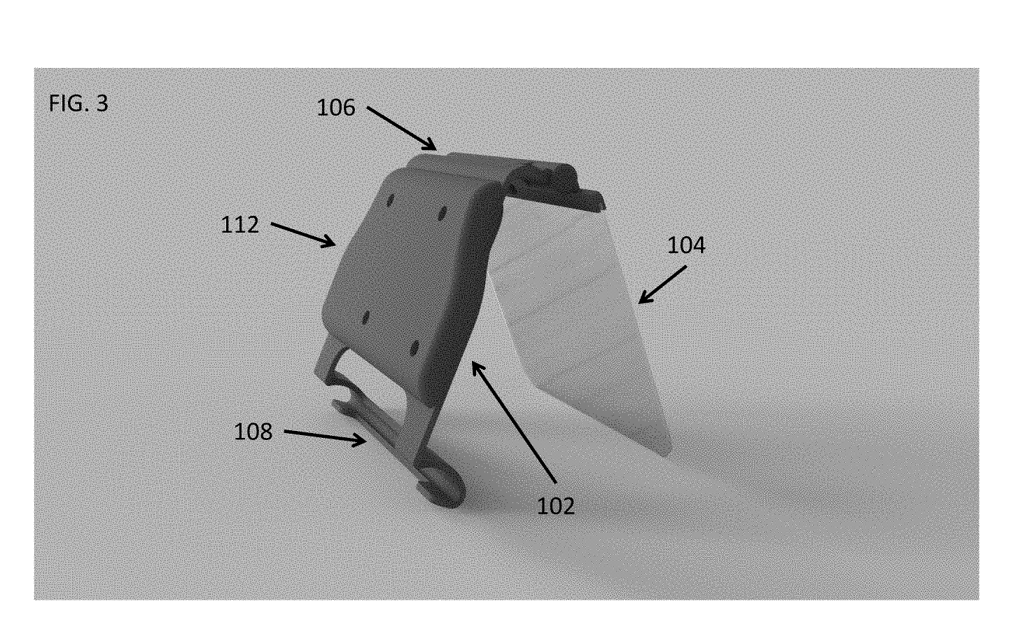

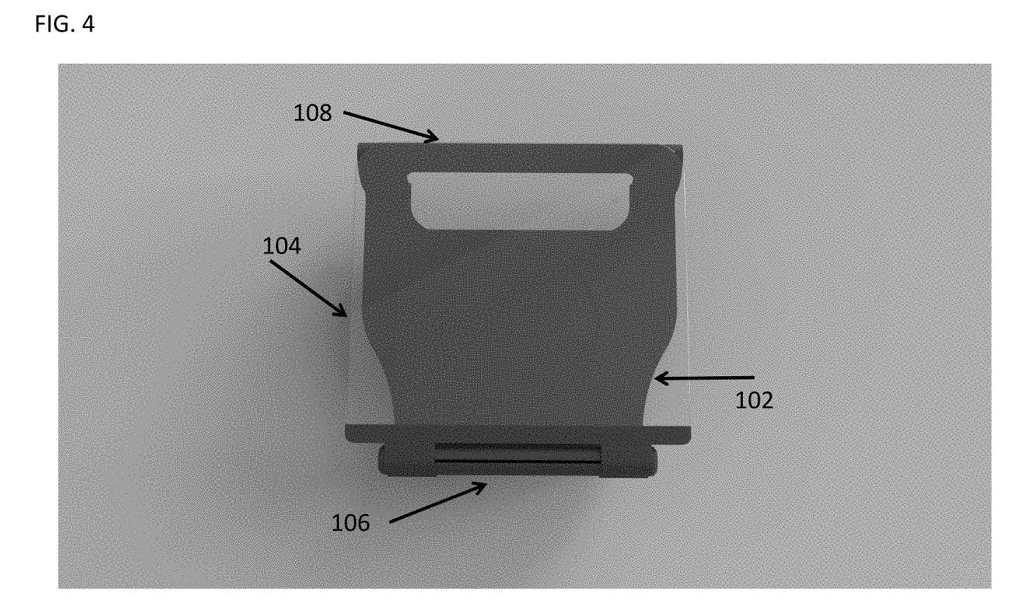

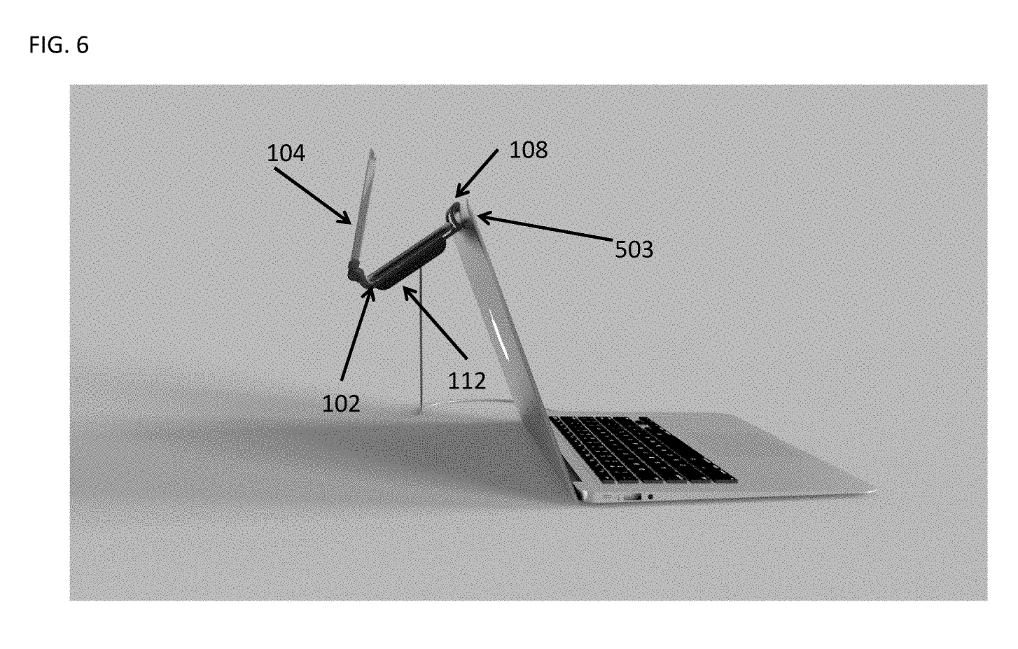

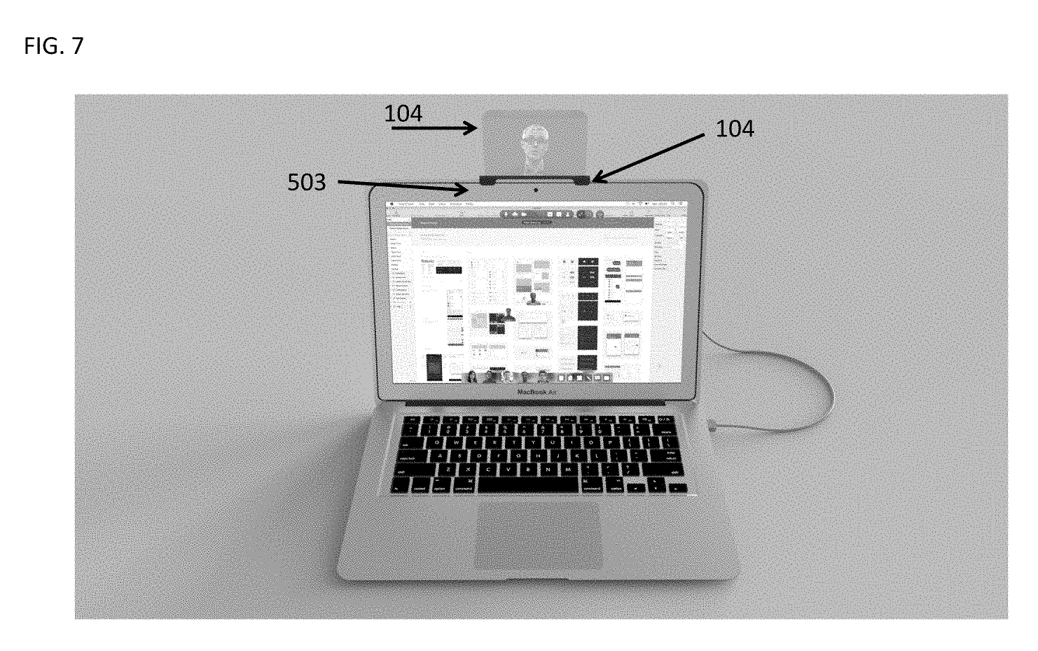

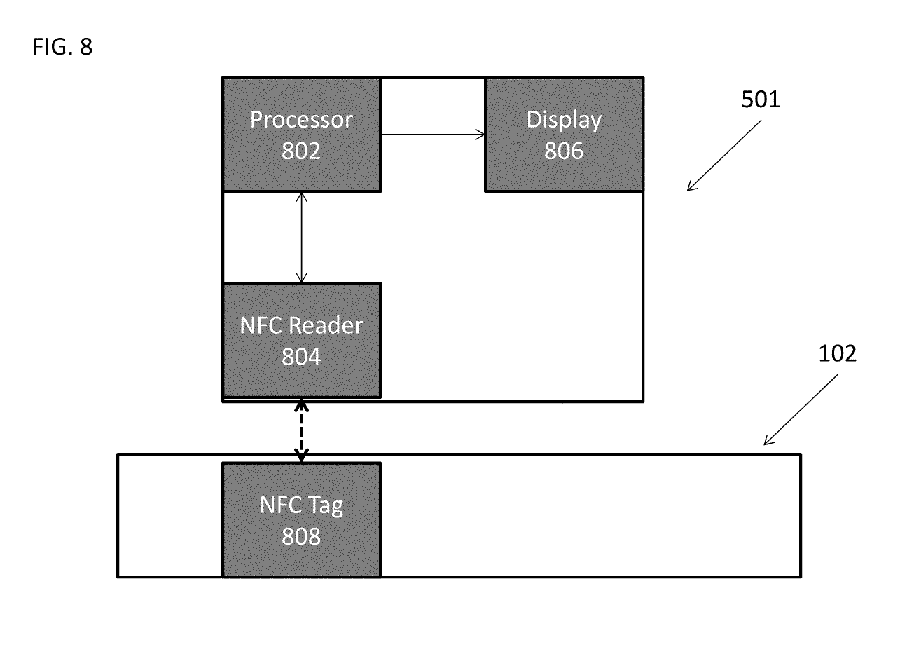

By way of broad overview, and with reference to FIGS. 1-8, the various embodiments of the apparatus and systems described herein are directed towards a display device adaptor 100 configured to provide or project images displayed by a display deice onto a semi-transparent display or surface.

By way of non-limiting example, the display device adaptor 100 positions a beam splitter mirror relative to the visible content generated by a display device such that the light generated by the display device is reflected off the beam splitter mirror to an observer and the light originating from behind the beam splitter mirror is also transmitted to the observer. Thus, the display device adaptor 100 described enables an observer to view the content provided by the display device while also viewing events transpiring within the field of view behind the semi-transparent display or surface.

With particular reference to FIG. 1, the display device adaptor 100 described includes a supporting body 102. The supporting body 102 includes a supporting surface that is oriented along, and in turn, defines a first plane (P1). In a particular implementation, the supporting surface of the supporting body 102 has sufficient dimensions to support a display device, such as a smartphone or tablet computing device, placed in contact with the supporting surface.

In one or more configurations, the supporting body 102 is formed of molded or cast materials, such as thermoplastic, resins and the like. Alternatively, the supporting body 102 is formed of metal, synthetic, natural, composite, or other commonly used materials that are suitable for the forms and purposes described herein.

In a particular implementation, the supporting body 102 couples to a beam splitter mirror 104. Beam splitter mirrors, beam splitter glass, one way mirrors and other similar optical devices simultaneously partially reflect and transmit light. In one particular implementation, a sheet of glass or plastic is coated with, or is encased within, a thin, near-transparent layer of metal (for example aluminum). This optical thin-film coating allows for the reflection and transmission of light to be set at specific ratios. By way of non-limiting example, the beam splitter mirror can be set to have 70%/30% transmittance to reflective properties. Alternatively, the beam splitter mirror can be manufactured to have 50%/50% transmittance to reflective properties. Because of the reflective and transmittance properties of beam splitter optical devices, such as beam splitter mirror 104, a light source can be reflected off of the mirror to an observer, while the same observer is able to observe light passing though the beam splitter mirror 104.

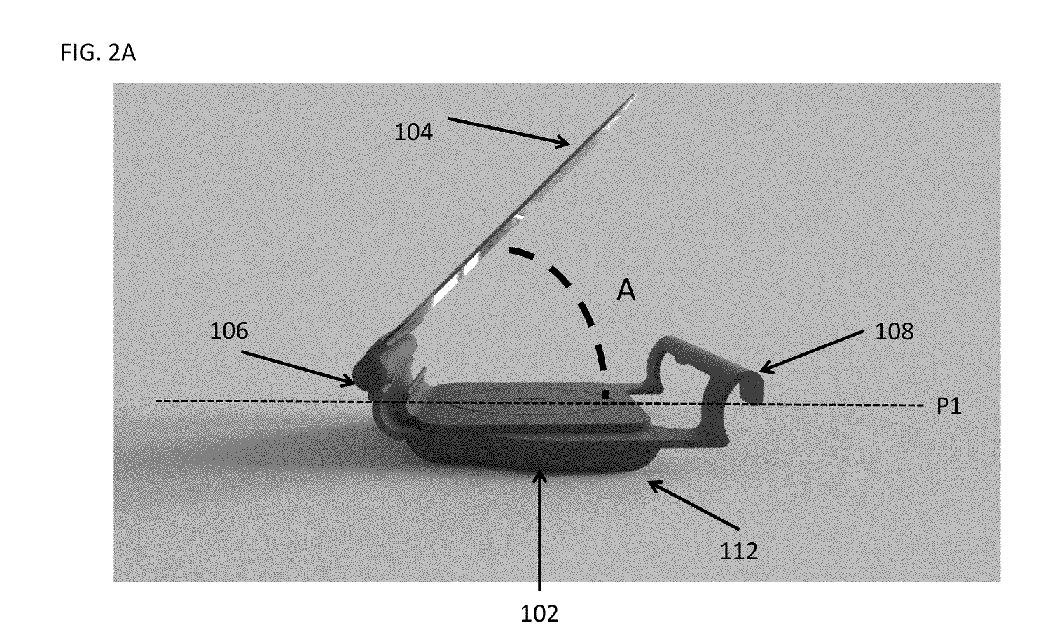

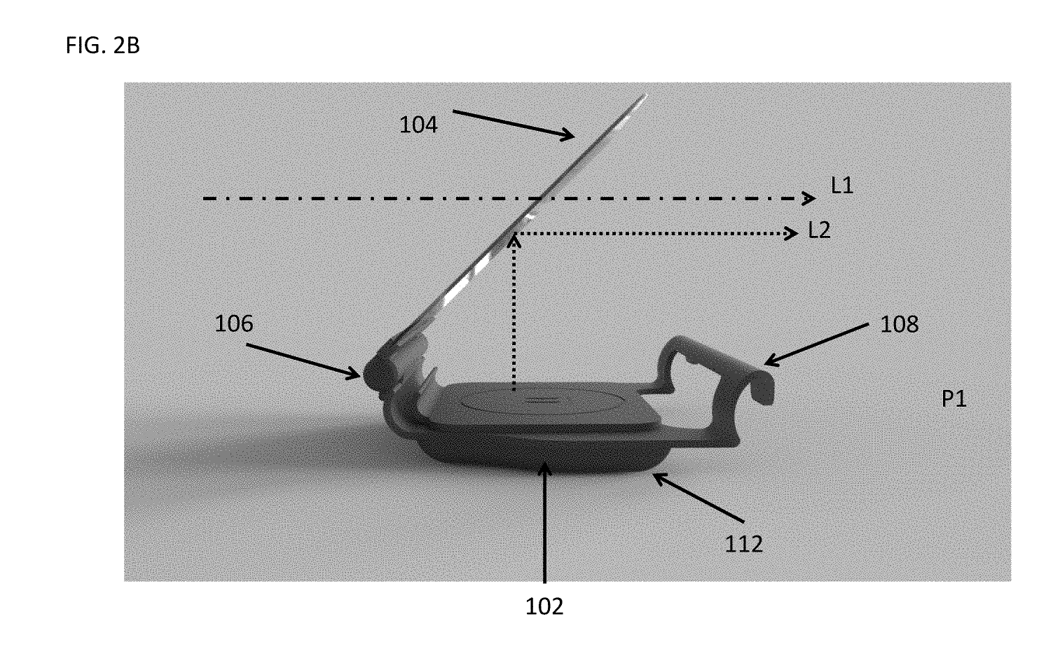

By way of further detail, in one implementation the beam splitter mirrors 104 include a glass plate with a reflective dielectric coating on one side (the so called “reflective” side) that provides a phase shift of 0 or π for light incident upon the beam splitter depending on the side from which side the light is incident. Without being held to any particular theory of operation, light waves incident upon the reflective side of the beam splitter glass are phase-shifted by π, whereas light incident upon the non-reflective side has no phase shift. As shown in FIG. 2B, such properties permit light traveling in a second direction (L2) to be mostly reflected, while light traveling in a first direction (L1) is mostly transmitted though the beam splitter mirror 104.

As shown in FIGS. 1 and 2A-B, the beam splitter mirror 104 is pivotable about an axis. For instance, beam splitter mirror 104 is coextensive or coupled to an angle adjustment device 106 that permits the movement of the beam splitter mirror 104 about an axis relative to the supporting body 102. In another implementation, the angle adjustment device 106 comprises a span or length of flexible or deformable material, springs, ratchet(s) or other devices or constructions that permit the angle of inclination of the beam splitter mirror 104 to be set and maintained relative to the supporting body 102.

In one particular orientation, as shown in FIG. 1, the beam splitter mirror 104 is configured in a closed position parallel to the first plane P1. Turning to FIGS. 2A-B, the beam splitter mirror 104 can be moved into a viewing position to allow an observer to view the surface of the beam splitter mirror 104 as well as the any light originating from behind the beam splitter mirror 104 (as shown by light path L1). In one implementation detailed in FIG. 2A, the beam splitter mirror 104 is positioned at a relative angle A from the first plane P1. For example, the beam splitter mirror 104 is positioned at an acute angle A relative to the plane P1. In one particular implementation, the beam splitter angle A is 45 degrees.

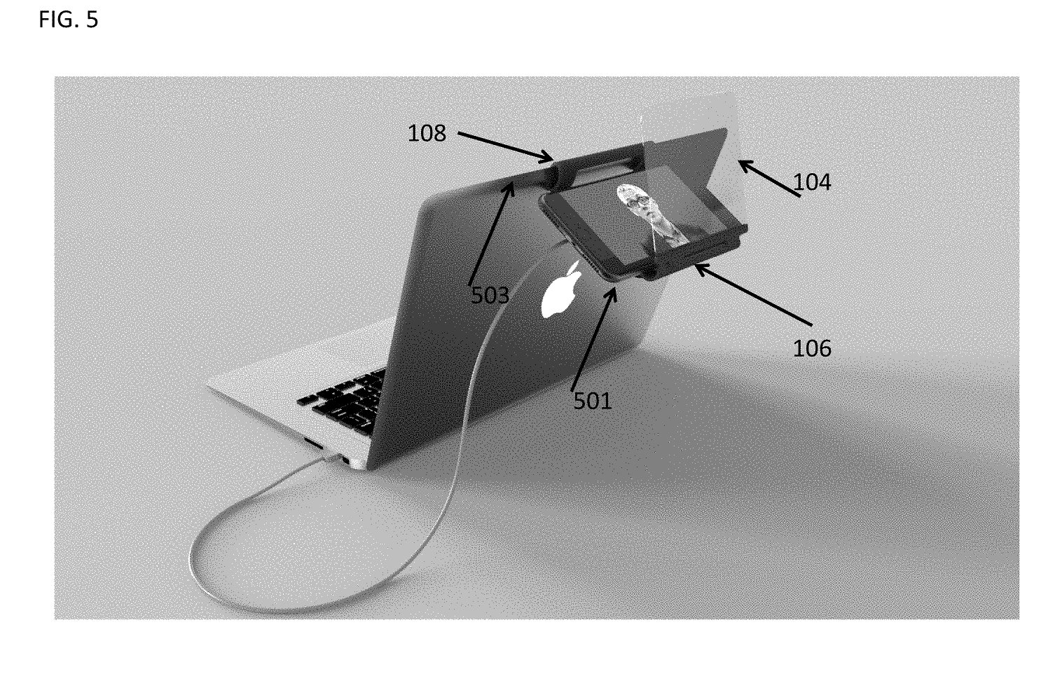

As shown with respect to FIGS. 5-7, the supporting body 102 further includes a surface attachment device 108. Here, the surface attachment device 108 couples the supporting body 108 to a surface 503. As shown, the surface attachment device 108 uses a hooked or curved receiver to secure the supporting body 102 to a surface 503. In an alternative configuration, the surface attachment device 108 utilizes clamps, adhesives, magnets, suction devices or the like to facilitate removable coupling to the surface 503.

As shown in FIGS. 5-7, the position of the surface attachment device 108 is fixed relative to the surface 503 and the supporting body 102. In one or more alternative implementations, the surface attachment device 108 includes one or more pivotable or adjustable elements that allow for the adjustment of the inclination or orientation of the supporting body 102 relative to the surface 503. For instance, the surface attachment device 108 also includes one or more hinges or other devices that enable the supporting body 102 to pivot about an axis.

In the illustrated implementations of FIGS. 5-7, the surface 503 is part of a computer display. In alternative configurations, the surface 503 can be a structural element, such as a door or wall, or furniture and portions thereof, such as desks and chairs. Furthermore, the surface 503 can be part of a larger device, construction or assemblage.

Returning to FIGS. 1-4, in one or more implementations, a device cradle 110 is integral to the supporting body 102. The device cradle 110 is configured to secure or otherwise hold a display device 501 when it is placed upon or in the supporting body. As shown in the illustrated embodiments, the device cradle 110 is configured to support the display device 501 when the supporting body 102 is engaged to a surface 503. In one implementation, the device cradle 110 includes clamps, straps, fasteners, adhesives, high friction coefficient materials, arrestors, or other devices and articles common in the art to removably secure one article to another.

As additionally shown in FIGS. 1-4 and 6, the supporting body 102 can also be further equipped with a power supply 112. Here, the power supply 112 includes one or more battery cells. In a further configuration, the cells are rechargeable cells. In one or more implementations, the power supply 112 includes input power, output power and control circuitry sufficient to permit the charging and discharging of the energy stored within the cells. For example, the power supply 112 is configured to be charged though a USB, Lightening Connector, FIREWIRE, HDMI or other port integrated into the supporting body 102 or the power supply 112 capable of transmitting power. Likewise, the energy stored within the cells can be discharged though similar connections and interfaces.

In a particular non-limiting implementation, the output of the power supply 112 is in communication with an inductive charging device. Here, inductive charging devices are devices configured to transmit power (electrical energy) wirelessly to a receiving device equipped with a suitable wireless power interface. Where the display device 501 includes such interfaces, the power supply 112 supplies power to the display device 501.

In yet a further implementation, the supporting body 102 includes or incorporates one or more near field communication tag(s) 808. For instance, the supporting body 102 includes Near Field Communication (NFC) tags of types 1 through 5 that contain data in the NFC Data Exchange Format (NDEF). Such NFC tags provide a suitably equipped computing device with data stored within the NFC tag.

With reference to FIG. 5, a display device 501 is placed upon the supporting body 102. Here, the display device 501 can be any device that outputs visible light. In a particular, non-limiting implementation, the display device 501 is a projection device. In a further implementation, the display device 501 includes a screen or integrated display. The light emitted by the screen of the display device is sufficient to be visible. For example, the display device 501 can be selected from cell phones, smartphones, MP3 players, tablet computers, GPS devices, or other portable electronic devices. For instance, the display device 501 can be a portable computing device such as Apple iPad/iPhones®, Android® devices or other electronic devices executing a commercially available or custom operating system, e.g., MICROSOFT WINDOWS, APPLE OSX, UNIX or Linux based operating system implementations.

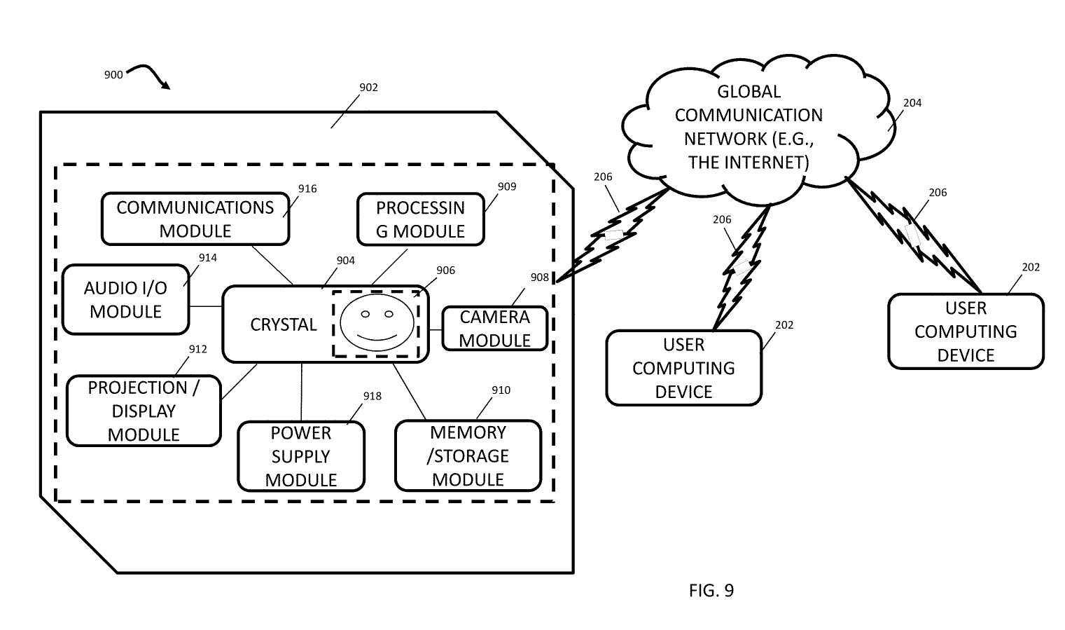

In one or more particular implementations as provided in FIG. 9, the display device 501 is a computing device having a processor 802 configured by code executing therein. In a particular implementation, the processor 802 is configured to access a NFC tag reader 804 that is in communication with the processor 802. Here, the processor 802 queries or exchanges data with a NFC tag 808 integral or associated with the supporting body 102. For example, the processor 802 of the display device 501 may execute one or more software programs that alter or augment the images displayed by the display device 501. Such software, configured as modules stored in the memory of the processor 802, can configure the display device 501 to invert or reverse the images provided by the display 806 of the display device 501. Upon interrogating the NFC tag 808, the processor 802 of the display device 501 receives data indicating that the display device has been placed within or on the supporting body 102. In response to this data, the processor 802, configured by code, alters the images generated by the display of the display device 501 in order to reverse the orientation of the displayed content. Since the light emitted by the display device will be reversed in orientation upon reflection off of the beam splitter mirror 104, the processor 802 of the display device 501 is thus instructed to provide an inversed image to the display 806 such that the non-reversed image of the content is provided to the observer viewing the content reflected off the of beam splitter mirror 104.

Processors, computing elements and microprocessors described herein are, in one or more implementations, connected, directly or indirectly, to one or more memory storage devices (memories). The memory is a persistent or non-persistent storage device that is operative to store an operating system for the processor in addition to one or more of software modules. In accordance with one or more embodiments, the memory comprises one or more volatile and non-volatile memories, such as Read Only Memory (“ROM”), Random Access Memory (“RAM”), Electrically Erasable Programmable Read-Only Memory (“EEPROM”), Phase Change Memory (“PCM”), Single In-line Memory (“SIMM”), Dual In-line Memory (“DIMM”) or other memory types. Such memories can be fixed or removable, as is known to those of ordinary skill in the art, such as through the use of removable media cards or modules. The computer memories may also comprise secondary computer memory, such as magnetic or optical disk drives or flash memory, that provide long term storage of data in a manner similar to the persistent memory device. In one or more embodiments, the memory of the processors provide for storage of application programs and data files when needed.

It will be further appreciated that computers, processors or computing devices described herein can communicate with the one or more remote networks using USB, digital input/output pins, eSATA, parallel ports, serial ports, FIREWIRE, Wi-Fi, Bluetooth, or other communication interfaces. In a particular configuration, Computing devices, processors or computers provided herein may be further configurable through hardware and software modules so as to connect to one or more remote servers, computers, peripherals or other hardware using standard or custom communication protocols and settings (e.g., TCP/IP, etc.) either through a local or remote network or through the Internet. Computing devices, processors or computers provided herein may utilizes wired or wireless communication means, such as, but not limited to CDMA, GSM, Ethernet, Wi-Fi, Bluetooth, USB, serial communication protocols and hardware to connect to one or more access points, exchanges, network nodes or network routers.

The processors or computers described are configured to execute code written in a standard, custom, proprietary or modified programming language such as a standard set, subset, superset or extended set of JavaScript, PHP, Ruby, Scala, Erlang, C, C++, Objective C, Swift, C#, Java, Assembly, Go, Python, Pearl, R, Visual Basic, Lisp, or Julia or any other object oriented, functional or other paradigm based programming language.

While this specification contains many specific embodiment details, these should not be construed as limitations on the scope of any embodiment or of what can be claimed, but rather as descriptions of features that can be specific to particular embodiments of particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features can be described above as acting in certain combinations and even initially claimed as such, one or more features from a claimed combination can in some cases be excised from the combination, and the claimed combination can be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the embodiments described above should not be understood as requiring such separation in all embodiments, and it should be understood that the described program components and systems can generally be integrated together in a single software product or packaged into multiple software products.

This application is now further described below, with reference to an alternative implementation.

By way of introduction and overview, in one or more implementations the present application provides systems and methods that include a display device that provides a three-dimensional, holographic appearance without requiring the use of laser light and associated technology to generate the appearance. In one or more implementations, the display device is configured with a crystalline portion, through which at least some visual content is displayed. By providing visual content through a transparent or translucent material, such as glass, plastic, crystal, or other suitable material, a futuristic holographic-looking display is provided, including in color.

In one or more implementations, three-dimensional color hologram looking images are projected as a function of hardware and software. Such images can be provided in a pre-recorded fashion, such as provide messages. Alternatively or in addition, the images can be provide in a dynamic environment, such as provided in TEAMTIME, and that supports video conferencing and configured to display individuals within the crystal or crystal-like material. As a person speaks, (s)he is featured individually within the crystal or crystal-like material, which gives the appearance of a personal physically in a room and present, even though that person may be thousands of miles away.

In one or more implementations, three-dimensionality is supported as a function of etching the crystalline structure, such as by a laser. Software can be executed by one or more processors to control an etching unit. For example, the head of a laser passes back and forth over the crystal or crystal-like material, which etches a shape into the crystal as a function of the focused beam of light and resulting in heat on the crystal or crystal-like material. In one or more implementation, subsurface laser engraving is employed that uses a physical mask, which ensures improved detail and can eliminate stray errors. This processes effectively cuts the crystal or crystal-like material and creates a design. The portion of the mask is removed, thereby exposing the crystal or crystal-like material that is etched. The three-dimensional map inside the crystal or crystal-like material features a dithering effect around a core generic head. A shape of a human head accommodates for different hairstyles, facial structure, glasses or other accessories, or the like, associated with respective persons being displayed.

In one or more implementations, the present application includes one or more modules that include code that, when executed by a processor, configures the processor to provide content within a predefined video frame shown on each of at least one display device. The module(s) configure the processor to provide the content such that the content does not appear to leave the frame, notwithstanding movement of the subject and/or capture device during capture.

For example, an area of a person's upper body (e.g., a person's head or face) is captured by a camera during a videoconference session. During movement (subject and/or camera movement), the body portion is tracked and the person's face (or upper body) is maintained within a centered portion of a display screen. In one or more implementations, a graphical user interface is provided on at least one computing device that includes one or more selectable controls and/or options, e.g., cursor controls, selection controls (e.g., round, rectangular, free-form selection tools), or other suitable control. During the point of capture (or at a point before or after), the user makes a selection, such as by a single-click action, a dragged selection of a region, or the like. The selection can be used by one or more processors to define a region within the frame where particular content (e.g., a person's head or face) is to be displayed, regardless of movement. Providing controls to enable users to make specific selections within a frame increases flexibility beyond simply confining content to the center of the frame. In addition to selecting the region where content is to be displayed, a user can use one or more controls to define a particular area of the subject (e.g., a person, an animal, vehicle or virtually any movable or non-movable subject) to be displayed in a defined region within a display. For example, by clicking on and/or selecting within an area associated with the subject, one or more processors can define a respective region to be tracked and maintained within the center or other previously defined region within the display, regardless of movement. Thus, as shown and described herein, the present application provides the benefit of keeping a face (head, or shoulders, etc.) positioned (e.g., centered) in a display screen during a videoconference or other video experience, and to offset distracting movements.

In one or more implementations, confining the display to a specific area of a subject within a specific region of a display can be accomplished in various ways. For example, a capture device, such as a camera, can be configured with one or more gyroscopes that detects particular camera movement. For example, as a user inadvertently moves the capture device, the area of the subject previously defined by the user moves in and out of the frame. One or more modules executing on one or more processors track the area substantially in real time, and the images are adjusted to offset the inadvertent movement in order to maintain the positioning of the area of the subject within the frame. In one or more recommendations, a calculation can be made in order to determine the percentage of the total subject to be included in the frame (e.g., X and Y coordinates of a face within the total frame). The calculation can be used to define vertical and/or horizontal percentage values for mapping the area of the subject to be maintained in a specific region within the frame. This can be accomplished by overscanning or other similar technique to preclude the entire captured frame from being displayed in the restricted field of view of the display device. As the capture device moves, the one or more gyroscopes detect the movements and information representing the motion is received and processed by one or more processors to adjust (e.g., reposition and/or resize) the overscanned area and maintain the area of the subject in the predefined region within the frame.

Accordingly, in one or more implementations head tracking and corresponding display is provided. The present application supports proper projection mapping thereof onto a specific portion of crystal or crystal-like structure, such as a 3-D surface comprising an etched masked surface 906. In this way, a person's face that is captured by an image receiver, such as a camera, is tracked, rescaled and then displayed in accurate position substantially in real-time.

In addition to registering display accurately, the present application supports forms of segmentation to separate a subject (e.g., a person) from the background. In one or more implementations, a virtual selection in an image of the subject is made substantially in real-time, and any non-selected portion of the image is replaced with a solid black color. In this way, the subject is segmented from the background, which substantially improves the appearance of the subject in the three-dimensional display device.

In one or more implementations, a gyroscope may not be accurate enough to provide information necessary to maintain the area of the subject precisely within the defined region. Moreover, one or more image capture devices may not be configured with a gyroscope. In such (or similar) circumstances, present application can include one or more modules to provide subject stabilization. Overscanning, as described above, is supported to preclude the entire captured image from being displayed in the entire frame of the display device. For example, the captured frame is cropped and the cropped portion is modified in response to detected movement (e.g., camera movement and/or subject movement). As the person or camera moves, the image(s) can be manipulated to maintain the subject (e.g., face) in the center of the display.

Referring to FIG. 9 a diagram is provided of an example hardware arrangement that operates for providing the systems and methods disclosed herein, and designated generally as system 900. System 900 can include one or more three-dimensional display devices 902 that are at least communicatively coupled to one or more user computing devices 202 across communication network 204 (e.g., the Internet). User computing devices 204 can include, for example, mobile computing devices such as tablet computing devices, smartphones, personal digital assistants or the like, as well as laptop computers and/or desktop computers. Further, one computing device may be configured as a data processing apparatus 902, which may include server capabilities, and a user computing device 202, depending upon operations be executed at a particular time.

Three-dimensional display device 902 can be configured with various circuitry and components, including some or all of which are displayed in FIG. 9. For example, crystal or crystal-like component 904 is provided that includes etched mask portion 906, on which a projection of video content is provided via projection/display module 912. Projection/display module 912 can include a light source, and bright light can shine through a small screen (e.g., a liquid crystal display (“LCD”) screen) on a lens (not shown). Moreover, in one or more implementations, a mirror, prism or other structure can be included to reflect and/or redirect the projected light. For example, including a mirror or the like to reflect the projected light can support positioning a projector in the three-dimensional display device 902 in various places. A projecting element can be placed from behind the etched mask portion 906, which may obviate a need for a mirror or other reflecting surface. In an alternative implementation, a projecting element is placed below the etched mask portion 906, and a mirror or other reflecting surface reflects the projected light on to the etched mask portion 906. In a preferred configuration, image content (e.g., video content) is projected through the lens to etched mask portion 906.

In addition, a visual capture device (e.g., a camera) 908 can be included as depicted in FIG. 9, and which can be configured with one or more cameras (e.g., front-facing and rear-facing cameras). Furthermore, an audio I/O module 914 can be provided and that includes one or more microphones, speakers, and/or audio circuitry (e.g., a sound card). In one or more implementations, processing module 909 is provided with three-dimensional display device 902, and module 909 includes a microprocessor, as well as a memory/storage module 910, which can store instructions to be executed by the processing module 909 to implement features shown and described herein. Memory/storage modules module 910 can include one or more of volatile and non-volatile memories, such as Random Access Memory (“RAM”), Read Only Memory (“ROM”), Flash, Phase Change Memory (“PCM”), or other type of memory. Further, communications module 916 can be included with three-dimensional display device 902, that includes components and circuitry for bi-directional communications, including over communication network 204 via communication pathways 206. Communications module 916 can use any known communication method, including Ethernet, direct serial, parallel, universal serial bus (“USB”) interface, and/or via a local or wide area network. Any and all of the components and modules can be powered by power supply module 918, which can include one or more batteries and/or a wired power source.

Three-dimensional display device 902 and/or any user computing device 904 can also include one or more input or output (“I/O”) devices and interfaces 225 which are provided to allow a user to provide input to, receive output from, and otherwise transfer data to and from the system. These I/O devices may include a mouse, keypad or a keyboard, a touch panel or a multi-touch input panel, camera, network interface, modem, other known I/O devices or a combination of such I/O devices (not shown). The touch input panel may be a single touch input panel which is activated with a stylus or a finger or a multi-touch input panel which is activated by one finger or a stylus or multiple fingers, and the panel is capable of distinguishing between one or two or three or more touches and is capable of providing inputs derived from those touches to the three-dimensional display device 902 and/or user computing device 904. The I/O devices and interfaces may include a connector for a dock or a connector for a USB interface, FireWire, etc. to connect with another device, external component, or a network.

Moreover, the I/O devices and interfaces can include gyroscope and/or accelerometer (not shown), which can be configured to detect 3-axis angular acceleration around the X, Y and Z axes, enabling precise calculation, for example, of yaw, pitch, and roll. The gyroscope and/or accelerometer can be configured as a sensor that detects acceleration, shake, vibration shock, or fall of a device 902/904, for example, by detecting linear acceleration along one of three axes (X, Y and Z). The gyroscope can work in conjunction with the accelerometer, to provide detailed and precise information about the device's axial movement in space. More particularly, the 3 axes of the gyroscope combined with the 3 axes of the accelerometer enable the device to recognize approximately how far, fast, and in which direction it has moved to generate telemetry information associated therewith, and that is processed to generate coordinated presentations, such as shown and described herein.

User computing devices 202 preferably have the ability to send and receive data across communication network 204, and are equipped with web browsers, software applications, or other software and/or hardware tools, to provide received data on audio/visual devices incorporated therewith. By way of example, user computing device 202 may be personal computers such as Intel Pentium-class and Intel Core-class computers or Apple Macintosh computers, tablets, smartphones, but are not limited to such computers. Other computing devices which can communicate over a global computer network such as palmtop computers, personal digital assistants (PDAs) and mass-marketed Internet access devices such as, for example, WebTV can be used. In addition, the hardware arrangement of the present invention is not limited to devices that are physically wired to communication network 204, and that wireless communication can be provided between wireless devices. In one or more implementations, the present application provides improved processing techniques to prevent packet loss, to improve handling interruptions in communications, and other issues associated with wireless technology.

Thus, as shown and described herein, production/display module 912 is configured to project on to a generic, three-dimensional etched mask portion 906. The images that are projected are properly registered, including as a function of one or more instructions executed by processing module 909 to adjust (e.g., reposition and/or resize) an overscanned area and to maintain the area of the subject in the predefined region within the frame and projected on the respective etched mask portion 906.

Although implementations shown in the figures illustrate various components apart from one another, the present application is not so limited. In one or implementations, all of the modules and/or components are contained with a single structure or housing to be contained within three-dimensional display device 902. In this way, a single unit can be placed on a desk or other surface (or simply held by a user), and can operate as shown and described herein without a need for additional and separate hardware and/or software.

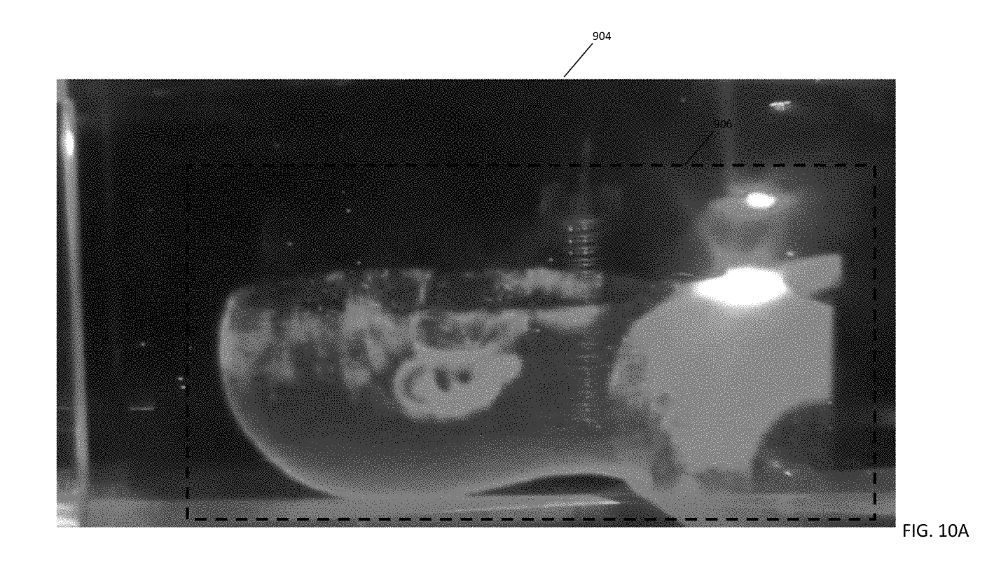

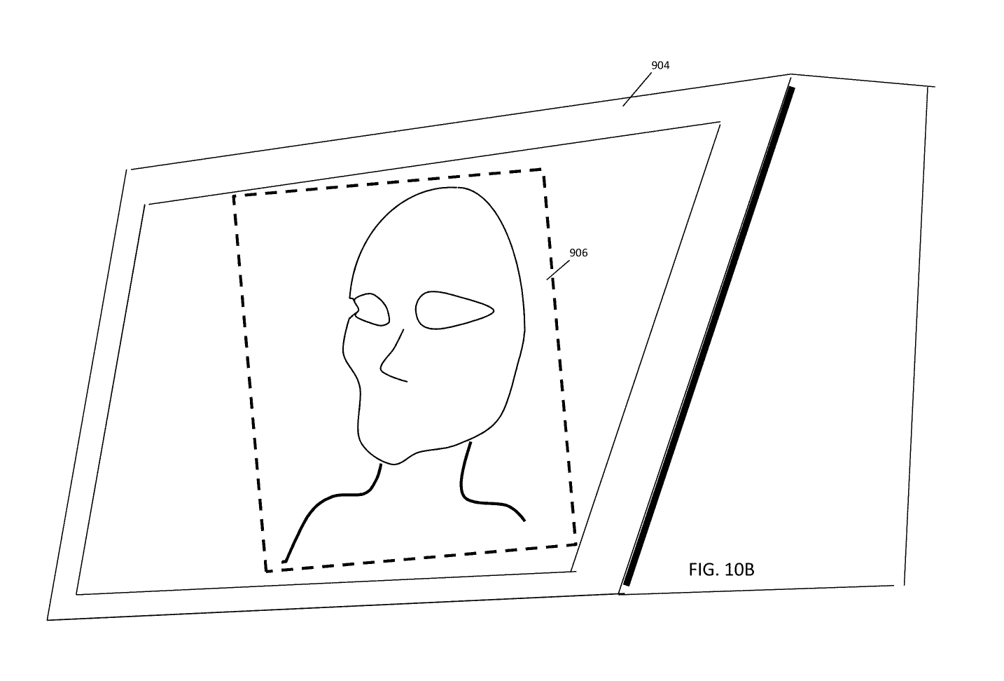

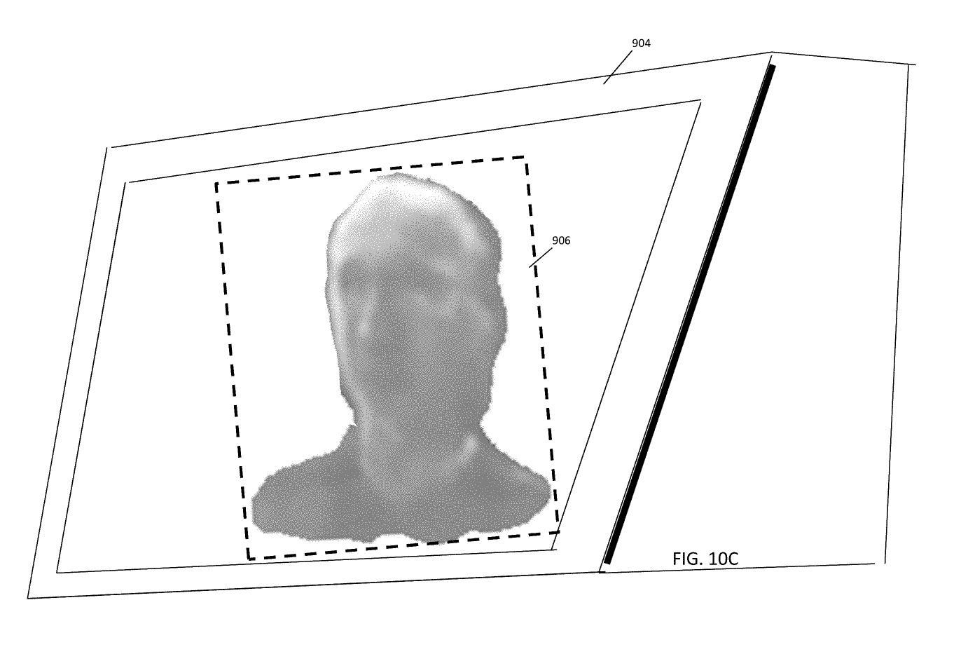

FIG. 10A is an illustration of a crystalline portion 904 during an etching process for creating the etched mask portion 906. As shown in FIG. 10A, a laser is in the process of etching a head and bust of a generic human form for etched mask portion 906.

FIG. 10B is a simple diagram illustrating an example crystal or crystal-like component 904 that includes etched mask portion 906 shown therein. As illustrated in FIG. 10B, etched mask portion 906 represents a head and bust of a generic human form. Accordingly, FIG. 10B illustrates the crystal or crystal-like component 904 and an image of a person projected onto etched mask portion 906.

FIG. 10C illustrates example the crystal or crystal-like component 904 that includes etched mask portion 906 and an image of a person projected on to etched mask 906. As can be seen in FIG. 2C, the projected image of the person is registered in line with etched mask portion 906, and the various images within etched mask portion 906 provides a three-dimensional and holographic appearance.

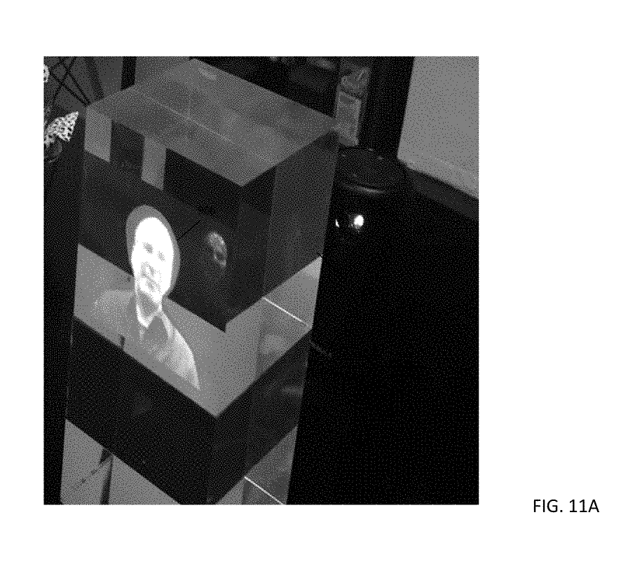

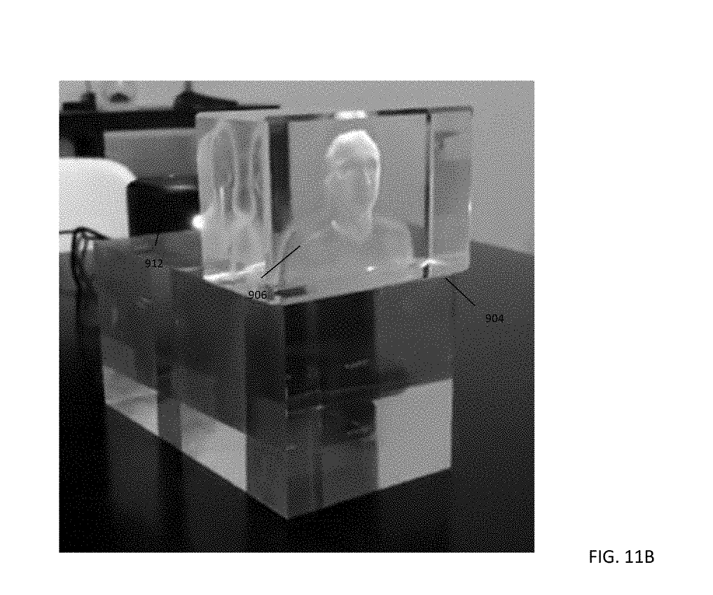

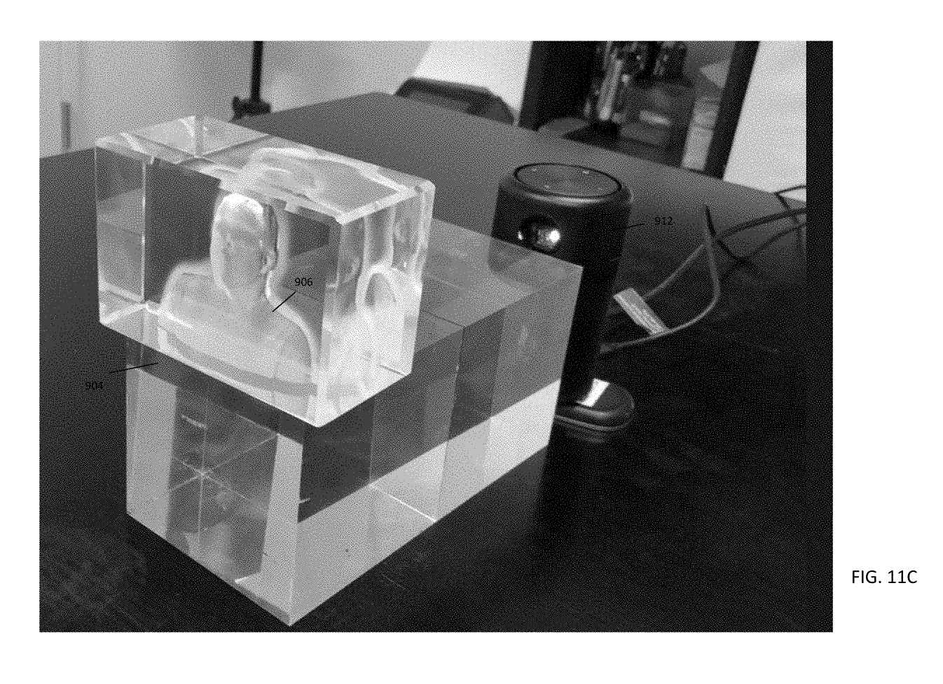

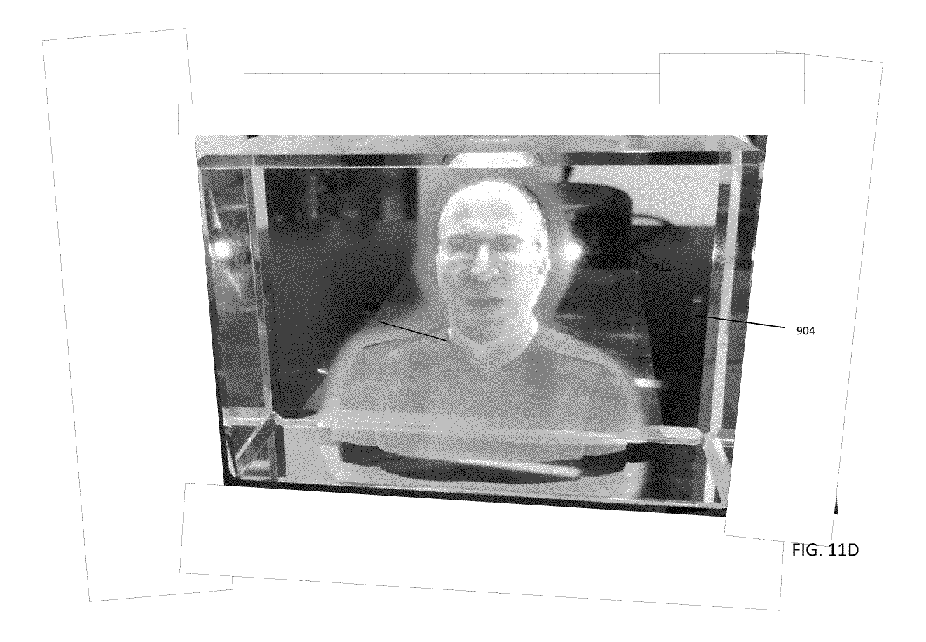

FIGS. 11A-11D illustrate example implementations of at least portions of system 900 and an alternative implementation. In the examples illustrated therein, images of a person projected on to etched mask portion 906 illustrate the holographic nature of the three-dimensional display device 902 provided in accordance with the teachings herein.

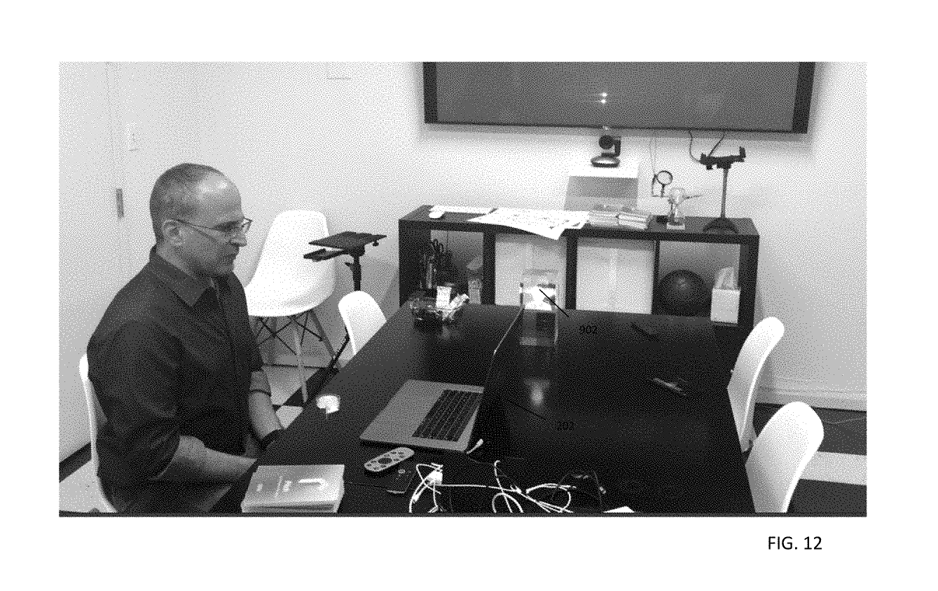

FIG. 12 illustrates an example implementation in which the user is engaged in a videoconference session and using technology shown and described herein. In the example shown in FIG. 12, the user is sitting in front of his laptop computer 202. Coupled to the computer 202, for example, wirelessly or via a wired connection, is three-dimensional display device 902 and that is projecting images of the user during the session.

Thus, as shown and described herein, technology is provided for an improved three-dimensional holographic-like display. Extending screen display onto a surface provided within or on a crystal or crystal-like structure in accordance with the teachings herein provides a novel and intriguing 3D shape inside a crystal or crystal-like, including to project a face thereon. In one or more implementations, a face and bust etched mask area is provided in full white, and images projected thereon fade out at the edges to blur and accommodate ears and hair. Using tracking functionality, such as shown and described herein, a person's face fills the respective etched portion inside the crystal or crystal-like material.

Furthermore, and in accordance with the teachings herein, a mask of a generic face is etched inside the crystal or crystal-like material, and light is projected on the surface of the crystal or crystal-like material 904, i.e., on the mask 906, thereby providing a 3-D display, such as of a face. The 3D etched portion 906 can be configured as approximately half of a face/bust and at least semi-hollow, such as a half shell profile of a generic human form with no mouth section. In this way, as images of a person are projected thereon, and the person speaks, there are no lips represented other than the projected lips. Similarly, no eyelids are preferably etched on the crystal or crystal-like material to preclude the movement of eyes and mouth, which are accomplished by projections. A 3-D presentation is accomplished in part due to the surface of the etched mask 906 on the 3-D surface of the crystal or crystal-like component 904, and having relief. The mask, effectively serves as convex-shaped screen, which provides a geometric effect. The video projector 912 projects the light onto the surface.

Unlike merely projecting onto a convex-shaped screen on a wall or other location, the image is significantly enhanced by being displayed through the crystal or crystal-like component. On a wall or other location, reflection of the light occurs, which affects the appearance of the projected image. The light passes through the crystal or crystal-like component and does not reflect away, thereby providing a bright and sharp image having good contrast and color.

Moreover, the present application supports improved positioning and alignment/registration of the projected image(s) with the etched mask on the subsurface of the crystal or crystal-like component. By etching a mask of a generic human face on the subsurface of the crystal or crystal-like component and using that mask as a support for displaying projected images brings the images to life in a new way that was previously only imagined.

In one or more implementations, the projection is provided from the rear of the etched mask. By placing the projection from the rear, the line of view of the display portion of the crystal or crystal-like component is not blocked or otherwise impeded for the viewer. Alternatively, the projection is from a direction other than the rear and a mirror or other reflective surface (e.g., a prism) is usable to redirect the projected image(s) to the etched mask, which can similarly prevent or avoid interfering with the viewpoint of the user.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

It should be noted that use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Particular embodiments of the subject matter described in this specification have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain embodiments, multitasking and parallel processing can be advantageous.

Publications and references to known registered marks representing various systems are cited throughout this application, the disclosures of which are incorporated herein by reference. Citation of any above publications or documents is not intended as an admission that any of the foregoing is pertinent prior art, nor does it constitute any admission as to the contents or date of these publications or documents. All references cited herein are incorporated by reference to the same extent as if each individual publication and references were specifically and individually indicated to be incorporated by reference.

While the invention has been particularly shown and described with reference to a preferred embodiment thereof, it will be understood by those skilled in the art that various changes in form and details are supported. For example, the present application provides significant flexibility and creativity in connection with creating and viewing coordinated presentations. Although illustrated embodiments of the present invention have been shown and described, it should be understood that various substitutions, and alterations can be made by one of ordinary skill in the art without departing from the scope of the present invention.

What is claimed is:

1. A display device adaptor comprising:
a supporting body defining a first plane and configured to support a display device;
a beam splitter mirror configured to transmit a portion of light incident upon it and reflect a portion of light incident upon it, the beam splitter positioned to receive and reflect light emitted by the display device and oriented at an acute angle relative to the first plane; and
a coupling device coupled to the supporting body configured to couple the supporting body to a surface.

2. A display device comprising:
a supporting body defining a first plane and configured to support a light projection device;
a beam splitter mirror coupled to the supporting body and pivotable about an axis, the beam splitter mirror configured to move from a closed position parallel to the first plane and a viewing position inclined at a relative angle from the first plane, the beam splitting mirror coextensive with the supporting body, wherein the beam splitter mirror is configured to transmit a portion of light incident upon it and reflect a portion of light incident upon it wherein the beam splitting mirror is positioned to reflect light generated by the light projection device; and
a coupling device coupled to the supporting body configured to couple the supporting body to a surface.

3. The display device of claim 1, wherein the light projection device is a computing device having at least one output display.

4. The display device of claim 1, further comprising a securing device, configured to secure the light projection device to the supporting body.

5. The display device of claim 1, wherein the relative angle is 45 degrees.

6. The display device of claim 1, further comprising a power supply.

7. The display device of claim 6, wherein the power supply includes at least one rechargeable cell.

8. The display device of claim 7, wherein the supporting body includes an inductive charging device coupled to the power supply.

9. The display device of claim 1, wherein the supporting body includes a near field communication device or tag.

10. A display device system:
a supporting body defining a first plane and configured to support a computing device and further configured with a near field communication tag;
a computing device having at least one light projecting portion and at least one near field communication tag reader; wherein the computing device is configured to:
evaluate data stored by the at least one near field communication tag, and generate an output signal for display to the display device in response to the evaluated sensor data, wherein the output signal causes the display of the display device to generate an reversed output;
a beam splitter mirror configured to transmit a portion of light incident upon it and reflect a portion of light incident upon it, the beam splitter positioned to receive light emitted by the display device and oriented at an acute angle relative to the first plane; and
a coupling device coupled to the supporting body configured to couple the supporting body to a surface.

11. The display adaptor of claim 1, wherein beam splitter has 70%/30% transmittance to reflective properties.

12. The display adaptor of claim 1, wherein beam splitter has 50%/50% transmittance to reflective properties.
